(19) United States
(12) Patent Application Publication
(10) Pub. No.: US 2010/0223464 A1
(43) Pub. Date: Sep. 2, 2010

(54) PUBLIC KEY BASED DEVICE AUTHENTICATION SYSTEM AND METHOD

(75) Inventors: Yun-Kyung Lee, Daejeon (KR); Jong-Wook Han, Daejeon (KR); Kyo-Il Chung, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/160,717

(22) PCT Filed: Jun. 22, 2007
(86) PCT No.: PCT/KR2007/003033

§ 371 Date: Jul. 11, 2008

(30) Foreign Application Priority Data
Oct. 24, 2006 (KR) 10-2006-0103693

(51) Int. Cl. H04L 9/32; H04L 9/08

(52) U.S. Cl. 713/168; 380/279

(57) ABSTRACT

Provided is a public key based device authentication server including a server authenticator identifying a device in which a service list is registered and acquiring a certificate of the device issued by a certificate authority (CA); and an encryption key generator generating a public key and a private key for the device and transmitting to the device the public key, the private key and the certificate of the device.

### TECHNICAL FIELD

The present invetion relates to a public key based device authentication system and method, and more particularly to a public key based device authentication system and method for providing a device service using a certificate and permission of a device in a network environment.

### BACKGROUND ART

In general, the term ‘authentication’ indicates user authentication, which manages a user's name, password, and the like through an authentication server to prove whether a user is authorized.

To overcome the disadvantages (e.g., ID share or ID piracy) of user authentication, research into device authentication methods for authenticating devices using device information have been carried out.

However, device authentication methods are provided for a limited number of devices, or use a private key rather than a public key or private information corresponding to the private key (devices are considered to have low computing power).

However, networking capable devices have basic computing power, and a public key algorithm includes a Rivest Shamir Adleman (RSA) algorithm and an elliptic curve cryptosystem (ECC) algorithm providing an easy operation, and thus a difficulty in a public key operation does not matter. Device authentication methods allocate a series of numbers to devices and identify the numbers in order to authenticate devices. However, device authentication methods are limited, since attempts to provide device services by more cooperation between devices and less user intervention are being made.

Device authentication methods for merely allocating a series of numbers to devices and identifying the numbers are vulnerable to eavesdropping attacks, replay attacks, man-in-the-middle (MIM) attacks or the like.

Furthermore, device authentication methods may be exposed to attacks by device providers (allocating a series of numbers to devices) and hacking attacks. Therefore, a public key based device authentication method is required to provide a secure network service.

### DISCLOSURE OF INVENTION

### Technical Problem

The present invention provides a device authentication system using a public key based certificate, an authentication server, a device, and an authentication method and a communication method using the public key based certificate.

### Technical Solution

According to an aspect of the present invention, there is provided a public key based device authentication server, comprising: a server authenticator identifying a device in which a service list is registered and acquiring a certificate of the device issued by a certificate authority (CA); and an encryption key generator generating a public key and a private key for the device and transmitting to the device the public key, the private key and the certificate of the device.

The public key based device authentication server may further comprise: a permission issuer authenticating the device based on the certificate of the device, and issuing permission of the device in order to access a counterpart device.

According to another aspect of the present invention, there is provided a public key based device, comprising: a permission acquirer acquiring a permission of the device including the location and public key of a counterpart device in order to access the counterpart device; and a communicator communicating data with the counterpart device based on the public key of the counterpart device.

The public key based device may further comprise: a device authenticator acquiring a certificate of the device issued by a CA, and a public key and a private key distributed according to a PKI based certificate authentication scheme.

### ADVANTAGEOUS EFFECTS

The public key based device authentication system and method according to the present invention provide a device authentication system, an authentication server, and a device using a public key based certificate, and a device authentication method and a device communication method using a public key based permission.

The public key based device authentication system according to the present invention authenticates the device using a certificate system so that a device authentication route is reduced, and when the device moves from a domain to another domain, a device authentication process is reduced.

The device is registered and a certificate of the device is issued using the authentication server so that the certificate of the device is easily issued. The authentication server generates a pair of a public key and a private key, which requires a lot of computing power and consumes a lot of time, so that the device having limited computing power can reduce operations.

The authentication server issues the permission so that peer-to-peer (P2P) communication between devices can be used to provide a service in a home network. The permission is confirmed using relatively easy operations of decrypting the permission and verifying a signature of the permission so that the numbers of operations performed by the devices can be reduced.

### DESCRIPTION OF DRAWINGS

FIG. 1 is a block diagram of public key based device authentication systems according to an embodiment of the present invention;

FIG. 2 is a block diagram of a public key based device authentication server according to an embodiment of the present invention;

FIG. 3 is a block diagram of a public key based device according to an embodiment of the present invention;

FIG. 4 is a flowchart illustrating a process of registering and authenticating a public key based device authentication server according to an embodiment of the present invention;

FIG. 5 is a flowchart illustrating a process of registering and authenticating a public key based device according to an embodiment of the present invention;

FIG. 6A is a view illustrating a permission issuance process in a public key based device authentication server according to an embodiment of the present invention;

FIG. 6B illustrates a permission according to an embodiment of the present invention; and

FIG. 7 is a view illustrating a communication method used for communication between public key based devices according to an embodiment of the present invention.

### BEST MODE

According to an aspect of the present invention, there is provided a public key based device authentication server, comprising: a server authenticator identifying a device in which a service list is registered and acquiring a certificate of the device issued by a certificate authority (CA); and an encryption key generator generating a public key and a private key for the device and transmitting to the device the public key, the private key and the certificate of the device.

The public key based device authentication server may further comprise: a permission issuer authenticating the device based on the certificate of the device, and issuing permission of the device in order to access a counterpart device.

According to another aspect of the present invention, there is provided a public key based device, comprising: a permission acquirer acquiring a permission of the device including the location and public key of a counterpart device in order to access the counterpart device; and a communicator communicating data with the counterpart device based on the public key of the counterpart device.

The public key based device may further comprise: a device authenticator acquiring a certificate of the device issued by a CA, and a public key and a private key distributed according to a PKI based certificate authentication scheme.

### MODE FOR INVENTION

The present invention will now be described more fully with reference to the accompanying drawings.

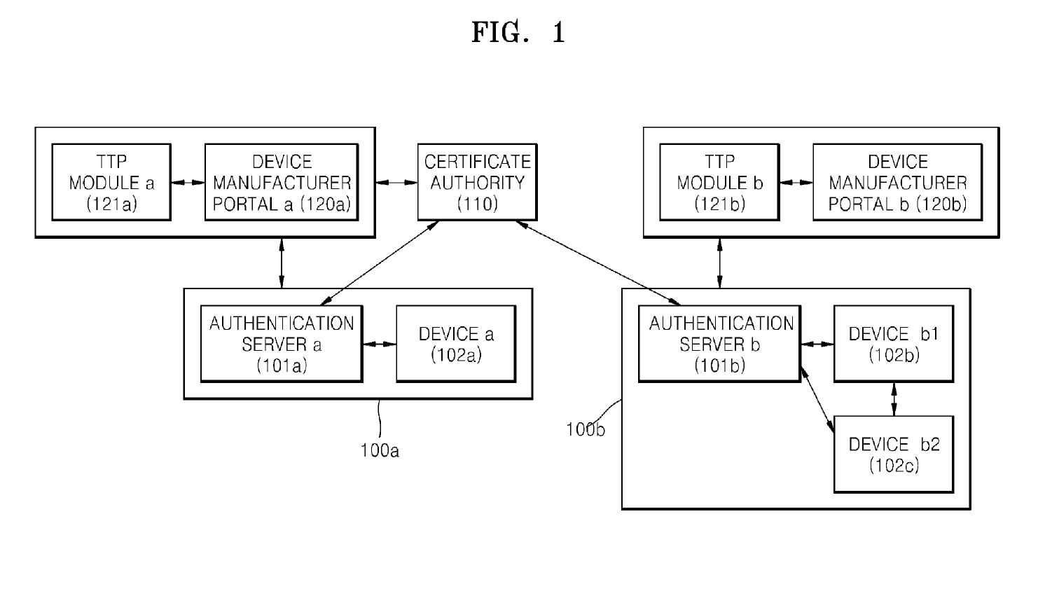

FIG. 1 is a block diagram of public key based device authentication systems 100a and 100b according to an embodiment of the present invention. Referring to FIG. 1, the public key based device authentication systems 100a and 100b of the present embodiment can be implemented with a certificate authority (CA) 110 and device manufacturer portals 120a and 120b.

The public key based device authentication systems 100a and 100b comprise an authentication server 101a and a device 102a, and an authentication server 101b and devices 102b and 102c, respectively, and follow a public key infrastructure (PKI) based certificate authentication scheme.

The authentication servers 101a and 101b and the devices 102a, 102b, and 102c belong to respective domains (physically a home, an office, a car interior, etc. and logically a group). The CA 110 is a subject that authenticates the authentication servers 101a and 101b and the devices 102a, 102b, and 102c.

In detail, the CA 110 is a higher authentication server and manages a certificate (e.g., certificate revocation, certificate renewal, certificate issuance, and certificate revocation list (CRL) management, and the like).

The CA 110 manages two or more domains and authenticates the two or more authentication servers 101a and 101b and the devices 102a, 102b, and 102c which belong to respective domains.

In detail, the CA 110 authenticates the two or more public key based device authentication systems 100a and 100b.

The authentication servers 101a and 101b and the devices 102a, 102b, and 102c are authentication objects of the CA 110. The authentication servers 101a and 101b issue a permission to the devices 102a, 102b, and 102c.

The authentication servers 101a and 101b function as registration authorities (RAs) when a device is registered and a device certificate is issued.

The device manufacturer portals 120a and 120b are portal servers run by device manufacturers, and identify the authentication servers 101a and 101b and the devices 102a, 102b, and 102c.

Trusted 3^{rd} party (TTP) modules 121a and 121b register and identify the authentication servers 101a and 101b, respectively, and may belong to the device manufacturer portals 120a and 120b, respectively. However, the TTP modules 121a and 121b can be servers managed by a 3^{rd} party.

The TTP modules 121a and 121b identify the authentication servers 101a and 101b, respectively, and domain representatives.

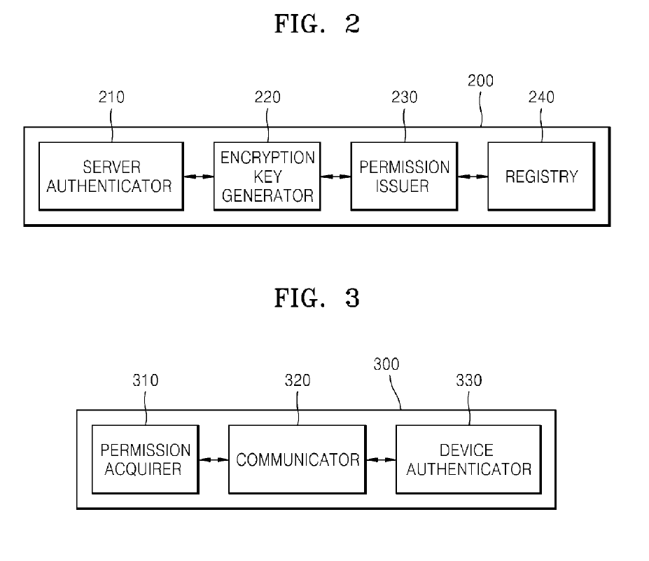

FIG. 2 is a block diagram of a public key based device authentication server 200 according to an embodiment of the present invention. Referring to FIG. 2, the public key based device authentication server 200 of the present embodiment comprises a server authenticator 210, an encryption key generator 220, a permission issuer 230, and a registry 240.

The server authenticator 210 identifies a device in which a service list is registered and acquires a certificate of the device issued by a CA. The server authenticator 210 and the CA communicate data using a pre-shared session key through mutual authentication.

The encryption key generator 220 generates a public key and a private key for the device and transmits to the device the public key, the private key and the certificate of the device. The public key and the private key follow a PKI based certificate authentication scheme.

The permission issuer 230 authenticates the device based on the certificate of the device, and issues a permission of the device to enable the device to access counterpart devices.

The permission of the device includes the location and public key of a counterpart device, and is encrypted based on the public key for the device and issued.

The registry 240 is authenticated by the CA and registers information on the ID, location, and representative of the device with the CA.

FIG. 3 is a block diagram of a public key based device 300 according to an embodiment of the present invention. Referring to FIG. 3, the public key based device 300 of the present embodiment comprises a permission acquirer 310, a communicator 320, and a device authenticator 330.

The permission acquirer 310 acquires a permission including the location and public key of a counterpart device in order to access the counterpart device.

The communicator 320 communicates data with the counterpart device based on the public key of the counterpart device.

The device authenticator 330 acquires a certificate of the public key based device issued by a CA, and a public key and a private key distributed according to a PKI based certificate authentication scheme.

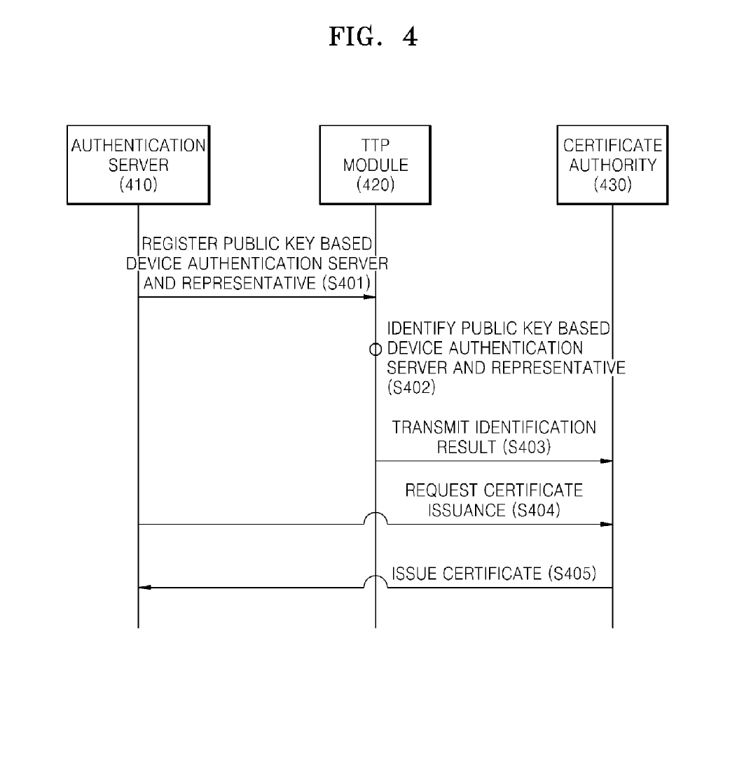

FIG. 4 is a flowchart illustrating a process of registering and authenticating a public key based device authentication server according to an embodiment of the present invention. Referring to FIG. 4, the public key based device authentication server 410 is registered with a TTP module 420, and a certificate of the public key based device authentication server 410 is issued by a CA 430.

If the public key based device authentication server 410 is purchased, it is necessary to register the public key based device authentication server 410 and a representative of a domain (home) (Operation 401).

The registration of the representative of the domain (home) is required since the public key based device authentication server 410 functions as a RA during a certificate issuance process and a subject needs to have legal and moral responsibility for a device registered by the RA.

After the public key based device authentication server 410 and the representative of the domain (home) are registered, the TTP module 420 identifies the public key based device authentication server 410 (through a device manufacturer portal) and the representative of the domain (home) (Operation 402).

If the public key based device authentication server 410 and the representative of the domain (home) are successfully identified, the CA 430 is notified of a result of the identification (Operation 403).

The public key based device authentication server 410 requests the CA 430 to issue the certificate of the public key based device authentication server 410 (Operation 404). If the CA 430 has received a message indicating that the public key based device authentication server 410 and the representative of the domain (home) are successfully identified, the CA 430 issues the certificate to the public key based device authentication server 410, and if not, the CA 430 rejects to issue the certificate to the public key based device authentication server 410 (Operation 405).

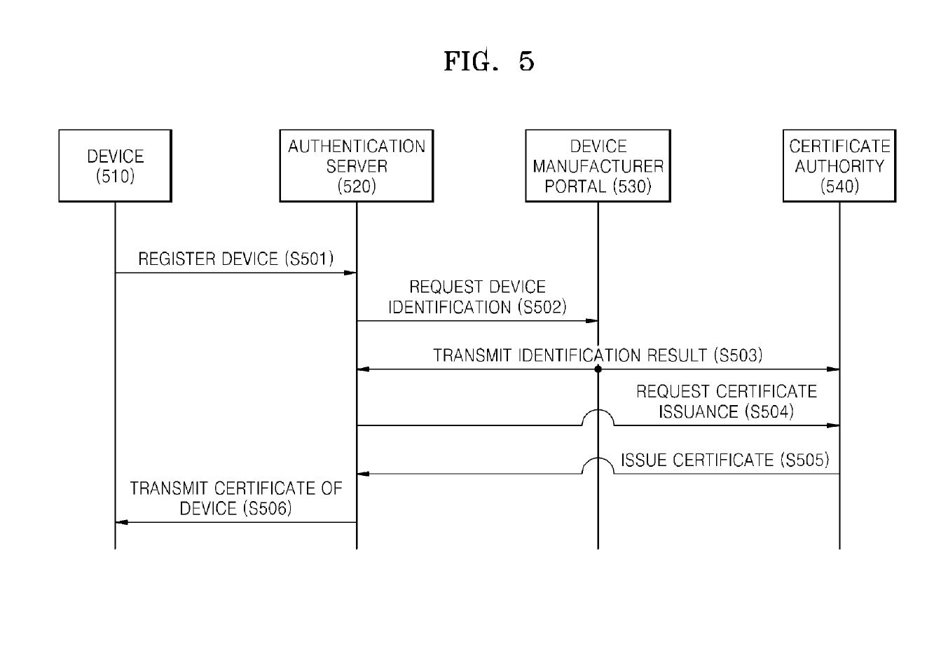

FIG. 5 is a flowchart illustrating a process of registering and authenticating a public key based device 510 according to an embodiment of the present invention. Referring to FIG. 5, the public key based device 510 is registered through an authentication server 520 and a certificate of the public key based device 510 is issued by a CA 540.

If the public key based device 510 is purchased, the location, service list, and user information of the public key based device 510 are registered with the authentication server 520 (Operation 501). The location, service list, and user information are required to issue the certificate and permission of the public key based device 510.

The authentication server 520 transmits the identity information of the public key based device 510 input by a user to a device manufacturer portal 530 and requests the device manufacturer portal 530 to identify the public key based device 510 (Operation 502). The device manufacturer portal 530 transmits a result of the identification to the authentication server 520 (Operation 503).

The result of the identification is also transmitted to the CA 540. A session key pre-shared through mutual authentication is used to communicate data between the authentication server 520 and the device manufacturer portal 530 and between the device manufacturer portal 530 and the CA 540.

If the public key based device 510 is successfully identified, the authentication server 520 generates a pair of a public key and a private key for the public key based device 510, and requests the CA 540 to issue the certificate of the public key based device 510 (Operation 504). The CA 540 issues the certificate or rejects to issue the certificate based on the result of the identification of the public key based device 510 (Operation 505).

The authentication server 520 transmits the pair of the public key and the private key and the certificate received from the CA 540 to the public key based device 510 (Operation 506).

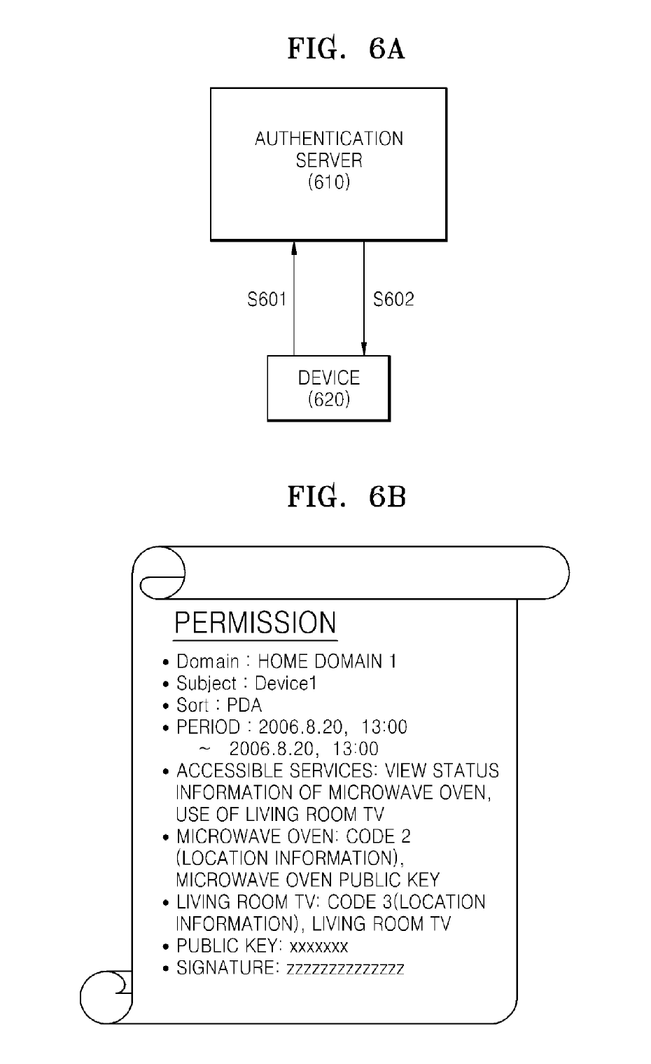

FIG. 6A is a view illustrating a permission issuance process in a public key based device authentication server 610 according to an embodiment of the present invention. Referring to FIG. 6A, the public key based device authentication server 610 authenticates a device 620 and issues a permission to the device 620.

When a user powers the device 620 on or requests the device 620 to provide a service, if the device 620 is not authenticated or the permission of the device 620 have expired, mutual authentication between the public key based device authentication server 610 and the device 620 is performed (Operation 601).

If the mutual authentication is successful, the public key based device authentication server 610 issues the permission and the device 620 acquires the permission (Operation 602).

FIG. 6B illustrates a permission according to an embodiment of the present invention. Referring to FIG. 6B, the permission of the present embodiment can be used in a domain managed by an authentication server and include a list of devices registered in the authentication server.

The permission includes a list of the device 620 and location information (IP address, etc.) and public key information of the device 620.

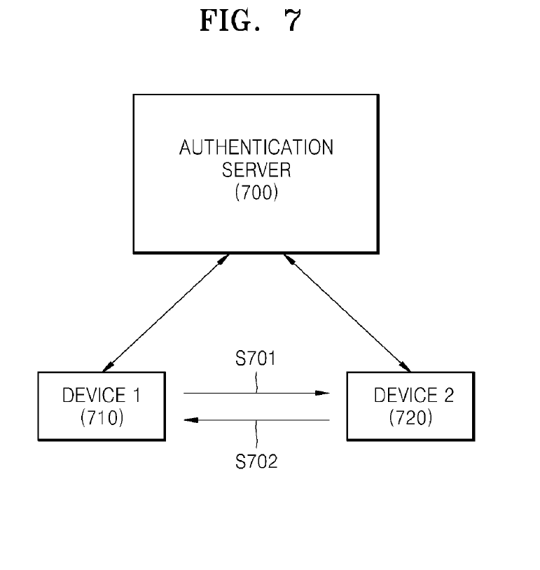

FIG. 7 is a view illustrating a communication method used for communication between public key based devices 710 and 720 according to an embodiment of the present invention. Referring to FIG. 7, the public key based devices 710 and 720 constitute a network using a permission without assistance of an authentication server 700 to provide or receive a service.

When a user requests a specific service to be provided, if cooperation between the public key based devices 710 and 720 is needed, public key based device 1 710 encrypts the permission received from the authentication server 700 using a public key (which is included in the permission) of public key based device 2 720 and transmits the encrypted permission to public key based device 2 720 (Operation 701).

Public key based device 2 720 decrypts the permission received from public key based device 1 710 using a private key of the public key based device 2 720, confirms the content of the permission, verifies a signature of the permission using a public key of the authentication server 700, and finally confirms that the permission is issued by the authentication server 700.

If the permission is successfully confirmed, public key based device 2 720 provides public key based device 1 710 with the service. However, if the confirmation of the permission fails, public key based device 2 720 does not provide public key based device 1 710 with the service (Operation 702).

It is possible for the present invention to be realized on a computer-readable recording medium as a computer-readable code. Computer-readable recording mediums include every kind of recording device that stores computer system-readable data. ROMs, RAMs, CD-ROMs, magnetic tapes, floppy discs, optical data storage, etc. are used as a computer-readable recording medium. Computer-readable recording mediums can also be realized in the form of a carrier wave (e.g., transmission through Internet). A computer-readable recording medium is dispersed in a network-connecting computer system, resulting in being stored and executed as a computer-readable code by a dispersion method.

The public key based device authentication system and method according to the present invention provide a device authentication system, an authentication server, and a device using a public key based certificate, and a device authentication method and a device communication method using a public key based permission.

The public key based device authentication system according to the present invention authenticates the device using a certificate system so that a device authentication route is reduced, and when the device moves from a domain to another domain, a device authentication process is reduced.

The device is registered and a certificate of the device is issued using the authentication server so that the certificate of the device is easily issued. The authentication server generates a pair of a public key and a private key, which requires a lot of computing power and consumes a lot of time, so that the device having limited computing power can reduce operations.

The authentication server issues the permission so that peer-to-peer (P2P) communication between devices can be used to provide a service in a home network. The permission is confirmed using relatively easy operations of decrypting the permission and verifying a signature of the permission so that the numbers of operations performed by the devices can be reduced.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the present invention is defined not by the detailed description of the invention but by the appended claims, and all differences within the scope of the present invention will be construed as being included in the present invention.

### INDUSTRIAL APPLICABILITY

The present invetion relates to a public key based device authentication system and method, and more particularly to a public key based device authentication system and method for providing a device service using a certificate and permission of a device in a network environment.

1. A public key based device authentication server, comprising:
a server authenticator identifying a device in which a service list is registered and acquiring a certificate of the device issued by a certificate authority (CA); and
an encryption key generator generating a public key and a private key for the device and transmitting to the device the public key, the private key and the certificate of the device.

2. The public key based device authentication server of claim 1, further comprising:
a permission issuer authenticating the device based on the certificate of the device, and issuing permission of the device in order to access a counterpart device.

3. The public key based device authentication server of claim 2, wherein the permission of the device include the location and public key of the counterpart device, and the permission of the device is encrypted based on the public key for the device and issued.

4. The public key based device authentication server of claim 1, further comprising:
a registry authenticated by the CA.

5. The public key based device authentication server of claim 1, wherein the public key and the private key follow a public key infrastructure (PKI) based certificate authentication scheme.

6. The public key based device authentication server of claim 4, wherein the registry registers two or more pieces of information on the ID, location, and representative of the device with the CA.

7. The public key based device authentication server of claim 1, wherein the server authenticator and the CA communicate data with each other using a pre-shared session key through mutual authentication.

8. A public key based device, comprising:
a permission acquirer acquiring a permission of the device including the location and public key of a counterpart device in order to access the counterpart device; and
a communicator communicating data with the counterpart device based on the public key of the counterpart device.

9. The public key based device of claim 8, further comprising:
a device authenticator acquiring a certificate of the device issued by a CA, and a public key and a private key distributed according to a PKI based certificate authentication scheme.

10. A public key based device authentication method, comprising:
identifying a device in which a service list is registered and acquiring a certificate of the device issued by a CA; and
generating a public key and a private key for the device and transmitting to the device the public key, the private key and the certificate of the device.

11. The public key based device authentication method of claim 10, further comprising:
authenticating the device based on the certificate of the device, and issuing a permission of the device in order to access a counterpart device.

12. The public key based device authentication method of claim 11, wherein the permission of the device includes the location and public key of the counterpart device, and is encrypted based on the public key for the device and issued.

13. The public key based device authentication method of claim 10, further comprising:
the public key based device being authenticated by the CA.

14. The public key based device authentication method of claim 10, wherein the public key and the private key follow a PKI based certificate authentication scheme.

15. The public key based device authentication method of claim 13, wherein when the public key based device is authenticated by the CA, two or more pieces of information on the ID, location, and representative of the device are registered with the CA.

16. The public key based device authentication method of claim 10, wherein the authentication server and the CA communicate data with each other using a pre-shared session key through mutual authentication.

17. A public key based device communication method, comprising:
acquiring a permission of the device including the location and public key of a counterpart device in order to access the counterpart device; and
communicating data with the counterpart device based on the public key of the counterpart device.

18. The public key based device communication method of claim 17, further comprising:
acquiring a certificate of the device issued by a CA, and a public key and a private key distributed according to a PKI based certificate authentication scheme.
